(19) United States
(12) Patent Application Publication
(10) Pub. No.: US 2006/0000108 A1
(43) Pub. Date: Jan. 5, 2006

(54) Method and apparatus for treating sludge using micro-wave and hot air

(75) Inventors: Sang-kook Cho, Seoul (KR); Euisin Lee, Yongin-si (KR); Seungmo Hong, Seongnam-si (KR); Hyunsu Park, Suwon-si (KR); Yongsei Lee, Seongnam-si (KR); Sungin Yoo, Seoul-si (KR); Younghwan Shin, Suwon-si (KR)

Correspondence Address: MERCHANT & GOULD PC, P.O. BOX 2903, MINNEAPOLIS, MN, 55402-0903, US

(73) Assignee: Daewoo Engineering & Construction Co., Ltd., Seoul (KR)

(21) Appl. No.: 11/219,246

(22) Filed: Sep. 2, 2005

(30) Foreign Application Priority Data
Mar. 2, 2004 (KR) 10-2004-0014040

(51) Int. Cl. F26B 19/00; F26B 3/34

(52) U.S. Cl. 34/259; 34/60

(57) ABSTRACT

Disclosed are a method and an apparatus for treating sludge such as sewage, waste water, etc. using micro-wave and hot air, wherein an energy required for the treatment of the sludge can be reduced and the efficiencies of reuse and treatment of the sludge can be improved by using the micro-wave and the hot air especially with heat-absorbing material to decompose and solubilize the sludge and to reduce a quantity of the sludge.

### BACKGROUND OF THE INVENTION

1. Field of the Invention

The present invention relates to a method and an apparatus for treating sludge using micro-wave and hot air, and particularly to a method and an apparatus for treating sludge such as sewage, waste water, etc. using micro-wave and hot air, wherein an energy required for the treatment of the sludge can be reduced and the efficiencies of reuse and treatment of the sludge can be improved by using the micro-wave and the hot air especially with heat-absorbing materials to decompose and solubilize the sludge and to reduce a quantity of the sludge.

2. Background of the Related Art

As prior methods for treating sludge, incineration, reclamation, stabilization using calcium hydroxide, treatment using earthworms and the like are known.

However, the prior methods are frequently restricted by environmental regulations. Accordingly, it is necessary to develop a new method for treating sludge, which does not cause environmental pollutions and can be free of such environmental regulations.

It is important to dry the sludge and reduce a quantity of the sludge when treating the sludge. The conventional reduction methods have been performed through a simple drying method wherein the sludge is heated so as that water can be removed from the sludge. However, according to the drying method, there are problems that considerable energy should be consumed and so there occur high costs for treating the sludge in that water can be removed from the sludge only by heating.

### SUMMARY OF THE INVENTION

Accordingly, the present invention has been made to solve the above problems occurring in the prior art. An object of the present invention is to provide a method and an apparatus for treating sludge wherein energy consumed for decomposition and solubilization of the sludge and reduction of a quantity of the sludge can be reduced, and an efficiency of anaerobic digestion of microbes in the sludge can be improved.

In order to achieve the above object, there is provided an apparatus for treating sludge comprising an agitating member for mixing the sludge with char and powder of active carbon, and a drying member, to which the mixed sludge is supplied, having a micro-wave generating member and a hot air heating member for heating inside of the drying member with hot air to a predetermined temperature, the mixed sludge supplied to the drying member being decomposed and solubilized and a quantity of the mixed sludge being reduced by using the micro-wave together with the hot air heating.

According to the invention, the apparatus may further comprise a recycling member by which a portion of the dried sludge discharged from the drying member may be recycled into the agitating member to be mixed with the sludge, the char and the powder of active carbon, and the mixture of the dried sludge, the sludge, the char and the powder of active carbon may be supplied again to the drying member.

According to the invention, an amount of the char and the powder of active carbon may be 1˜10 wt. % based on the mixture.

According to the invention, the apparatus may further comprise a condensing member for extracting condensed water, which can be used as an external carbon source, from a gas discharged from the drying member and a bio filter removing a stench from the gas discharged from the drying member.

In order to achieve the above object, there is provided a method for treating sludge comprising steps of mixing the sludge with char and powder of active carbon, and then illuminating the mixed sludge with micro-wave and heating the mixed sludge with hot air to decompose and solubilize the mixed sludge and to reduce a quantity of the mixed sludge.

According to the invention, a portion of the dried sludge discharged after the decomposition and solubilization of the mixed sludge and the reduction of the quantity of the mixed sludge may be recycled to be mixed with the sludge, the char and the powder of active carbon, and then the mixture of the dried sludge, the sludge, the char and the powder of active carbon may be again decomposed and solubilized and a quantity of the mixture may be reduced.

According to the invention, the char and the powder of active carbon may be mixed with the dried sludge and sludge in the amount of 1˜10 wt. % based on the mixture.

According to the invention, the method may further comprise steps of condensing a gas occurring from the sludge in the step of the decomposition and solubilization of the mixed sludge and the reduction of the quantity of the mixed sludge to extract condensed water, which can be used as an external carbon source, and removing a stench from the gas occurring from the sludge in the step of the decomposition and solubilization of the mixed sludge and the reduction of the quantity of the mixed sludge using a bio filter.

### BRIEF DESCRIPTION OF THE DRAWINGS

FIG. 1 is a schematic view showing a process and an apparatus for treating sludge according to the invention.

FIG. 2 is a graph showing variations of water contents of the sludge in the respective cases that only hot air heating is carried out and a micro-wave is used together with the hot air heating.

FIG. 3 is a graph showing variations of water contents of the sludge according to the hot air heating, the hot air heating with using the micro-wave, and the hot air heating with using the micro-wave under reduced pressure.

### DETAILED DESCRIPTION OF THE PREFERRED EMBODIMENTS

Hereinafter, preferred embodiments of the present invention will be described with reference to the accompanying drawings.

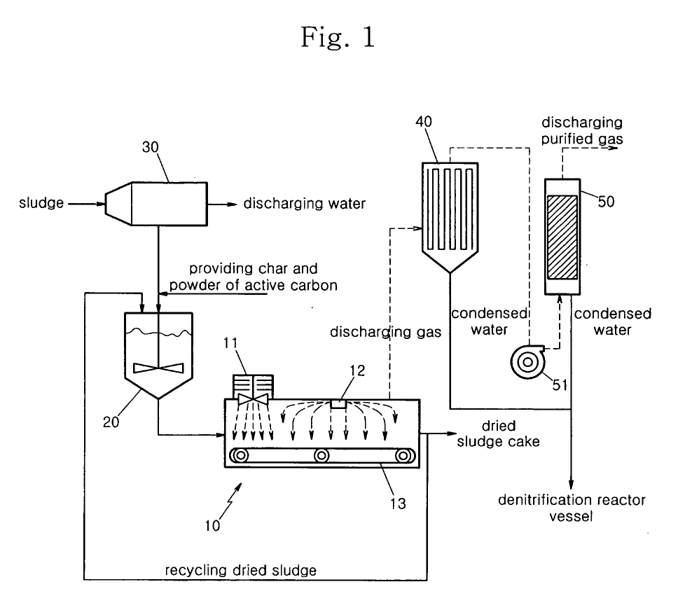

FIG. 1 is a schematic view showing a process and an apparatus for treating sludge according to the invention. As shown in FIG. 1, an illumination using micro-wave and a heating using, for example, hot air are used so as to dry the sludge and to reduce a quantity of the sludge when treating the sludge. In particular, the apparatus for treating the sludge according to the invention comprise a drying member 10. The drying member 10 comprises a micro-wave generating member 11 for generating micro-wave and a hot air heating member 12 for heating inside of the drying member 10 using hot air to a predetermined temperature.

The micro-wave generating member 11 generates micro-wave having a frequency range of about 300 MHz to 300 GHz. Herein, a wavelength of the micro-wave is within a range of about 1 cm to 1 m. The hot air heating member 12 produces hot air having a high temperature and blows the hot air to the sludge. The drying member 10 is preferably heated to have a temperature of 100° C.˜120° C.

It is also preferable that the sludge is primarily dewatered to a predetermined level by a centrifugal concentrator 30 before the sludge is supplied to the drying member 10. Herein, the dewatered sludge has a water content of about 75%˜80%.

The sludge is put on a conveyor belt 13 and passes through the drying member 10. The micro-wave generating member 11 of the drying member 10 generates a micro-wave to illuminate the sludge with the micro-wave. When the sludge is illuminated with the micro-wave, ions and polar materials (for example, water, pigment, fat and the like) contained in the sludge repeat the change of their arrangement with a very fast speed due to the energy of the micro-wave thereby causing molecular vibrations. To this end, cell membranes of microbes such as bacteria contained in the sludge are destroyed. Further, accelerated is an extraction phenomenon that a water-soluble organic material (solute) is effused from the microbes contained in the sludge to a solvent. As a result of that, improved is an efficiency of the anaerobic digestion of the sludge.

Further, according to the invention, the sludge is heated with the hot air heating member 12 in addition to the illumination of the sludge with the micro-wave. That is, the hot air heating member 12 serves as a heat source and blows a hot air having a high temperature to the sludge, which has been illuminated with the micro-wave. With such a heating, water is evaporated from the sludge so that the sludge is dried and formed into a cake shape, and then discharged from the drying member 10.

When the sludge is illuminated with the micro-wave in combination with the heating according to the invention, the effect of reducing a quantity of the sludge can be further redoubled.

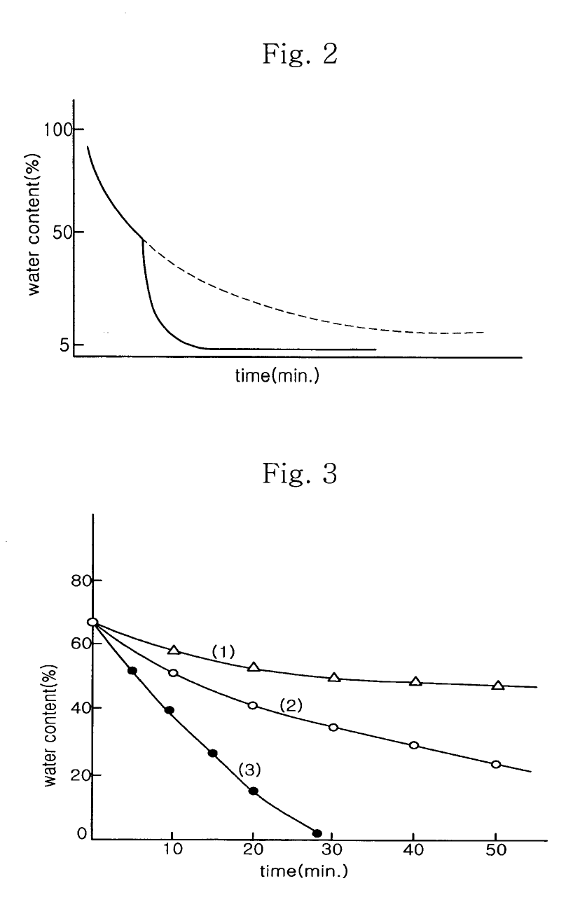

FIG. 2 is a graph showing variations of water contents of the sludge in the respective cases that only hot air heating is carried out (this is shown with a dotted line) and the micro-wave is used together with the hot air heating (this is shown with a full line). As shown in FIG. 2, it can be seen that the water content of the sludge is dramatically reduced when the heating and the micro-wave illumination are carried out together. Therefore, it can be seen that excellent effects of decomposition and solublilization of the sludge and reduction of the quantity of the sludge are obtained by using the heating and the micro-wave illumination together.

Further, a pressure in the drying member 10 is preferably reduced to a predetermined pressure when heating the sludge with hot air and illuminating the sludge with the micro-wave in the drying member 10.

In FIG. 3, there is a graph showing a relation between the water content of the sludge and the time when the sludge is heated to 45° C. only with the hot air [indicated as (1) in the graph], a relation between the water content of the sludge and the time when the heating and the micro-wave illumination are used under the same conditions [indicated as (2) in the graph], and a relation between the water content of the sludge and the time when the heating and the micro-wave illumination are used under condition that the pressure in the drying member 10 is reduced to 70 torr [indicated as (3) in the graph]. As can be seen from FIG. 3, when the pressure in the drying member 10 is reduced to the predetermined pressure according to the invention, the reduction of the quantity of the sludge can be further accelerated. When the pressure in the drying member 10 is reduced, a preferable pressure range in the drying member 10 may be 50˜70 torr.

The sludge supplied to the drying member 10 is dried with the micro-wave generating member 11 and the hot air heating member 12 in the drying member 10 and the quantity of the sludge is reduced. Then, the sludge is formed into a cake shape and discharged. According to the invention, a portion of the dried sludge discharged in the shape of the cake is recycled to the drying member 10 as described in detail later.

According to the invention, following process and structure may be further provided. That is, before the sludge (the dewatered sludge as well as the recycled sludge are not excluded) is supplied to the drying member 10, the char and the powder of active carbon are added to the sludge.

Referring to FIG. 1, the sludge from the centrifugal concentrator 30 and the recycled dried sludge form the drying member 10 are agitated and mixed with char and powder of active carbon in an agitating member 20 and then supplied to the drying member 10. Herein, an amount of the char and the powder of active carbon are preferably 1˜10 wt. % based on the mixture of the dried sludge, the sludge, the char and the powder of active carbon. In the case that the amount of the char and the powder of active carbon is less than 1 wt. %, the effect of the mixing the sludge with the char and the powder of active carbon is very slight. In the case that the amount is more than 10 wt. %, an economical efficiency is lowered because of too much auxiliary material of the char and the powder of active carbon compared to the sludge.

In particular, the char and the powder of active carbon absorb the micro-wave and thus serve as auxiliary material for increasing a temperature. Accordingly, if the char and the powder of active carbon are mixed with the sludge before the sludge is supplied to the drying member 10 as described above, the mixed sludge can reach a high temperature (maximum about 90° C.) in a very short time when the mixed sludge is illuminated with the micro-wave in the drying member 10. Therefore, it is possible to decrease the energy and the time required for drying the sludge and reducing the quantity of the sludge.

The sludge, which has been dried in the drying member 10 to have a reduced quantity, is formed into a cake shape. Further, it is preferred that a portion of the dried sludge is again recycled to the agitating member 20 by a recycling apparatus (not shown) and then mixed with the sludge (the dewatered sludge is not excluded as described above), the char and the powder of active carbon.

The sludge, which has been dried in the drying member 10 to have a reduced quantity, is formed into a cake shape having a water content of about 30˜50%. Because such a dried sludge is mixed with the sludge having an amount of water which is more than that of the dried sludge, it is possible to reduce the overall energy required for the decomposition and solubilization of the sludge and the reduction of the quantity of the sludge in the drying member 10 compared to the case that such a dried sludge is not mixed with the sludge.

According to the invention, the evaporated water from the drying member 10 is condensed with a condensing member 40 so that the condensed water is used as an external carbon source. Specifically, the water discharged from the drying member 10 is supplied to the condensing member 40 and then condensed to form condensed water. Since the condensed water contains an organic acid component, it may be supplied to an anaerobic/anoxic biological reactor vessel in the plant for treating sludge to be used as an external carbon source, which can replace ethanol for denitrification and phosphorous release. The organic acid can be easily decomposed with microbes in the biological reactor vessel. Since the current sewage, etc. are absolutely deficient in the amount of the organic required for a process for biologically removing nitrogen and phosphorous, the condensed water containing the organic acid can be usefully used.

Further, according to the invention, a bio filter 50 is used as a device for removing a stench from the gas occurring during the decomposition and solubilization of the sludge and the reduction of the quantity of the sludge. The gas occurring from the drying member 10 is supplied to the bio filter 50 via the condensing member 40. The bio filter 50 includes bacteria (Pseudomonas sp., Thiobacillus sp., Nitrosomonas sp., Bacillus sp., etc.) decomposing organic/inorganic of microbes. Accordingly, the stench from the gas can be removed with the bio filter 50 so that the gas can be discharged to the exterior without having the stench. Thus, it is possible to prevent the stench from occurring when treating the sludge. A fan 51 for blowing the gas is further used.

As described above, according to the invention, the micro-wave illumination and the heating is used together for the decomposition and solubilization of the sludge and the reduction of the quantity of the sludge. Accordingly, it is possible to improve the efficiency of the reduction of the quantity of the sludge due to a synergy effect resulting from the joint use of the micro-wave illumination and the heating, thereby reducing the energy consumption. In particular, according to the invention, since the cells of the microbes contained in the sludge are destroyed using the micro-wave, it is possible to improve the anaerobic digestion efficiency.

In addition, according to the invention, the sludge is mixed with the char and the powder of active carbon and then subject to the micro-wave illumination and the heating to perform the decomposition and solubilization of the sludge and the reduction of the quantity of the sludge. Herein, since the char and the powder of active carbon serve as a source of absorbing the micro-wave, the mixed sludge illuminated with the micro-wave can reach a high temperature in a very short time. Therefore, it is possible to decrease the energy and the time required for the decomposition and solubilization of the sludge and the reduction of the quantity of the sludge.

Further, according to the invention, the dried sludge cake from the drying member is mixed with the sludge to be treated together with the char and the powder of active carbon, then supplied again to the drying member and circulated as stated in the foregoing, so that it is possible to reduce the energy consumed in the drying member for the decomposition and solubilization of the sludge and the reduction of the quantity of the sludge.

Moreover, according to the invention, the condensing member is further provided to extract the condensed water, which can be usefully used as an external carbon source, from the gas occurring in the course of the decomposition and solubilization of the sludge and the reduction of the quantity of the sludge. Further, the bio filter is provided to remove and discharge the stench of the gas, so that it is possible to treat the sludge without exerting a bad influence on the environments.

Many alterations and modifications may be made by those having ordinary skill in the art without departing from the spirit and scope of the invention. Therefore, it must be understood that the embodiment described above should not be taken as limiting the invention as defined by the following claims. The claims are thus to be understood to include what is specifically described above, what is conceptionally equivalent, what can be obviously substituted and also what essentially incorporates the essential idea of he invention.

What is claimed is:

1. An apparatus for treating sludge comprising:
an agitating member for mixing the sludge with char and powder of active carbon; and
a drying member, to which the mixed sludge is supplied, having a micro-wave generating member and a hot air heating member for heating inside of the drying member with hot air to a predetermined temperature,
the mixed sludge supplied to the drying member being decomposed and solubilized and a quantity of the mixed sludge being reduced by using the micro-wave together with the hot air heating.

2. The apparatus according to the claim 1, wherein the apparatus further comprises a recycling member by which a portion of the dried sludge discharged from the drying member is recycled into the agitating member to be mixed with the sludge, the char and the powder of active carbon, and the mixture of the dried sludge, the sludge, the char and the powder of active carbon is supplied again to the drying member.

3. The apparatus according to the claim 2, wherein an amount of the char and the powder of active carbon is 1˜10 wt. % based on the mixture.

4. The apparatus according to the claim 1, wherein the apparatus further comprises a condensing member for extracting condensed water, which can be used as an external carbon source, from a gas discharged from the drying member.

5. The apparatus according to the claim 1, wherein the apparatus further comprises a bio filter removing a stench from the gas discharged from the drying member.

6. A method for treating sludge comprising steps of:
mixing the sludge with char and powder of active carbon; and then
illuminating the mixed sludge with micro-wave and heating the mixed sludge with hot air to decompose and solubilize the mixed sludge and to reduce a quantity of the mixed sludge.

7. The method according to the claim 6, wherein a portion of the dried sludge discharged after the decomposition and solubilization of the mixed sludge and the reduction of the quantity of the mixed sludge is recycled to be mixed with the sludge, the char and the powder of active carbon, and then the mixture of the dried sludge, the sludge, the char and the powder of active carbon is again decomposed and solubilized and a quantity of the mixture is reduced.

8. The method according to the claim 7, wherein the char and the powder of active carbon are mixed with the dried sludge and sludge in the amount of 1˜10 wt. % based on the mixture.

9. The method according to the claim 6, wherein the method further comprises condensing a gas discharged after the decomposition and solubilization and the reduction to extract condensed water, which can be used as an external carbon source.

10. The method according to the claim 6, wherein the method further comprises removing a stench from the gas discharged after the decomposition and solubilization and the reduction using a bio filter.
